(19) United States
(12) Patent Application Publication
(10) Pub. No.: US 2010/0156671 A1
(43) Pub. Date: Jun. 24, 2010

(54) DEVICE AND METHOD FOR ASSISTING A PARKING MANEUVER OF A VEHICLE

(76) Inventors: Wei-Chia Lee, Leonberg (DE); Markus Henzler, Notzingen (DE)

Correspondence Address: KENYON & KENYON LLP, ONE BROADWAY, NEW YORK, NY, 10004, US

(21) Appl. No.: 11/988,912

(22) PCT Filed: Jul. 18, 2006
(86) PCT No.: PCT/EP2006/064376

§ 371 Date: Mar. 11, 2010

(30) Foreign Application Priority Data
Aug. 9, 2005 (DE) 10 2005 037 468.9

(51) Int. Cl. B60Q 1/48

(52) U.S. Cl. 340/932.2

(57) ABSTRACT

A device for assisting a parking maneuver of a vehicle, in particular a motor vehicle, into a parking space situated transverse to the vehicle, having a parking space measuring device with a sensor system, and an evaluation unit, connected to the sensor system, for determining a parking trajectory of the vehicle into the parking space. For precise parking assistance, a selection device connected to the evaluation unit is provided for selecting a parking trajectory from a number of different parking trajectories determined by the evaluation unit. Also described is a method for assisting a parking maneuver of a vehicle, in particular a motor vehicle, into a parking space situated transverse to the vehicle by use of such a device.

### FIELD OF THE INVENTION

The present invention relates to a device for assisting a parking maneuver of a vehicle, in particular a motor vehicle, into a parking space situated transverse to the vehicle, having a parking space measuring device with a sensor system, and an evaluation unit, connected to the sensor system, for determining a parking trajectory of the vehicle into the parking space. The present invention further relates to a method for assisting a parking maneuver of a vehicle, in particular a motor vehicle, into a parking space situated transverse to the vehicle by use of a device of the aforementioned type, the parking space measuring device performing an at least partial geometric measurement of the parking space before the vehicle is parked in the parking space, and based on the measurement of the parking space the evaluation unit determining a parking trajectory of the vehicle into the parking space.

### BACKGROUND INFORMATION

A parking assistance device and a parking assistance method are described in European Application No. EP 1 462 342 A2 for backing a vehicle into a parking space situated transverse to the vehicle. A rear camera is provided for recording an image, displayable on a screen, of a rear region of the vehicle. For determining a target parking position, the driver of the vehicle is able to shift and rotate a parking space border which may be superimposed on the image. Based on an instantaneous position of the vehicle, the parking assistance device computes a path for achieving the target parking position specified by the driver. If the target parking position cannot be achieved for the vehicle, the parking assistance device prompts the driver to specify a revised target parking position.

In addition, a device referred to as a semiautomatic parking assistance system (SPA) is known for semiautomatic parking of a motor vehicle. The device, for which a driver of the motor vehicle must operate the steering wheel as well as the accelerator and brake pedals of the vehicle, computes a curved trajectory for parking the motor vehicle in a lateral parking space situated lengthwise to the vehicle to be parked, based on geometric information obtained from a parking space measurement and from vehicle geometry data for the vehicle to be parked. The parking space measurement uses a sensor system on the vehicle with the help of which the parking space is detected and measured when the motor vehicle travels past the parking space and/or during an approach of the motor vehicle to the parking space. To park the vehicle in the parking space, the driver follows the curved trajectory computed by the parking assistance system. Depending on the surroundings of the parking space, there may be a risk of collision and the inability to perform the parking maneuver following the computed curved trajectory provided by the parking assistance system.

### SUMMARY

An object of the present invention is to provide a device of the aforementioned type for assisting a parking maneuver of a vehicle which further simplifies the parking and provides a driver of the vehicle with precise parking assistance even under difficult surrounding conditions. A further object of the present invention is to provide a method for assisting a parking maneuver by use of such a device.

The first-referenced object may be achieved according to the present invention, for example, using an example device of the aforementioned type where a selection device connected to the evaluation unit is provided for selecting a parking trajectory from a number of different parking trajectories determined by the evaluation unit.

The second-referenced object may be achieved according to the present invention, for example, using an example method of the aforementioned type where at least two different parking trajectories are determined by the evaluation unit, and by use of the selection unit one of the determined parking trajectories is selected as the actual parking trajectory.

Example methods and devices according to the present invention are suitable for assisting a driver of a vehicle, in particular a motor vehicle, specifically, a passenger vehicle as well as a commercial vehicle, in parking, preferably backing-in parking, into a parking space situated transverse to the vehicle; i.e., according to the present invention the longitudinal extension of the parking space is oriented transverse, preferably at an angle of 90°, with respect to the longitudinal axis of the vehicle which is traveling past the parking space and is to be parked. Such a parking space is also generally referred to as a transverse parking space.

Using a parking space measuring device, in particular a sensor system, which is preferably situated laterally on the vehicle and facing the parking space, the parking space measuring device performs an at least partial geometric measurement of the parking space as the vehicle travels past the parking space; geometric data for the parking space which might not be detected in the measurement may be supplemented by the parking space measuring device using, for example, typical parking space models stored in the parking space measuring device. Possible parking trajectories into the parking space are determined based on the measurement of the parking space and taking into account fixed vehicle geometry data specified by the vehicle itself which is to be parked. One advantage of the present invention may be that one particular parking trajectory which is suitable in the individual case may be selected from a number of parking trajectories of the vehicle into the parking space which are possible in principle. This selection may be performed automatically, for example, assisted by default values and/or conditions stored in the device according to the present invention, or, for example, it may be performed manually by the driver, taking into account surrounding conditions instantaneously recognized by the driver which, for example, are not completely detected by the sensor system for system-related reasons, and/or the driver's judgment. In principle, for parking in a transverse parking space, starting from an actual position of the vehicle to be parked, the device according to the present invention may determine different parking trajectories which all result in the same target position of the parked vehicle and are characterized by a straight, aligned parking of the vehicle. The present invention offers the possibility of selecting from these parking trajectories in question, which differ, for example, with regard to the required parking moves during parking and/or a required maximum steering wheel angle, the parking trajectory which in each case is the most suitable. The vehicle is guided into the parking space along the selected parking trajectory which represents the actual parking trajectory for the parking maneuver. If the device according to the present invention is, for example, a component of a semiautomatic parking assistance system, the driver, using acoustic and/or visual signals, for example, and following the selected actual parking trajectory, may be informed of actions which he must perform in order to park the vehicle in the parking space. The vehicle is thus advantageously parked in a precisely aligned manner with regard to limitations of the parking space, for example adjacent parked vehicles and/or a curb. By use of the present invention, the driver preferably may himself decide which type of parking trajectory is selected for the parking trajectory, and the driver may base the selection on, for example, the parking trajectory that is easiest for him to follow. Clothoids may preferably be used for determining the parking trajectory by the evaluation unit; as trajectories having a constant change in curvature, clothoids offer the advantage that they are particularly easy to follow by the driver. A use of clothoids also makes it possible to steer during travel, it not being necessary for the driver during the parking maneuver to steer while the vehicle is standing still. The present invention is also suitable for parking in which the driver performs steering, braking, and acceleration of the vehicle, as well as for parking in which the steering is performed automatically and the activity of the driver is limited to the braking and acceleration in addition to a monitoring function, and is also suitable for fully automatic parking in which the driver performs only a monitoring function.

The selection device preferably has a display device, in particular a screen, for displaying the various parking trajectories in order to easily and clearly communicate these trajectories to the driver.

The device according to the present invention may advantageously be operated in a particularly simple manner when the selection device has an input device for selecting one of the various parking trajectories. The input device may, for example, have a manually operable switch, or may be a component of a screen having touch input (touch screen).

It is advantageous when the evaluation unit has a memory unit for storing a selected parking trajectory, so that one or more previously selected, preferred parking trajectories may be used for subsequent parking maneuvers. For example, it is possible that a driver of the vehicle routinely prefers a parking trajectory which allows parking using a single parking move.

A dependable geometric measurement of the parking space with high operational reliability and comparatively low cost of the sensor system may advantageously be achieved when the sensor system has a distance-measuring sensor, in particular an ultrasonic sensor.

To further simplify parking, it may be particularly advantageous to provide an output device for transmitting information to an operator of the vehicle concerning a vehicle operation for guiding the vehicle along the selected parking trajectory into the parking space. The output device may, for example, operate acoustically with a speaker, and/or visually with a screen.

In the example method according to the present invention it may be advantageous when the various determined parking trajectories are simultaneously displayed by use of the display device so that an operator, in particular the driver, of the vehicle is able to immediately perceive the possible available parking trajectories all at once.

The selection of the actual parking trajectory may advantageously be simplified when the various determined parking trajectories are in a sequence. When the actual parking trajectory is automatically selected by the selection device itself, in principle the first parking trajectory, for example, in the sequence may be selected.

In particular for simplifying a selection of a parking trajectory which allows a parking maneuver requiring the fewest possible parking moves, it may be particularly advantageous when the sequence of parking trajectories is a function of the minimum total number of parking moves to be performed for parking along the particular parking trajectory. The parking trajectory which requires the lowest number of parking moves is preferably first in the sequence.

When a display device is used for displaying the parking trajectories, the completeness and clarity of the display is additionally increased when the displays of the parking trajectories are designated according to their sequence. For example, the parking trajectories may be designated by consecutive Arabic numerals, or the minimum number of parking moves required for the particular parking trajectory may be indicated on the parking trajectories.

Preferably at least one of the various parking trajectories is determined by use of the evaluation unit in such a way that the parking maneuver may be performed by using a single parking move. This offers the opportunity to park in the parking space in a simple manner without changing the direction of travel.

If a large area is available for performing the parking maneuver without the risk of collision, in particular for a parking maneuver having small steering wheel angles it is advantageous when at least one of the various parking trajectories is determined by use of the evaluation unit in such a way that the parking maneuver may be performed using two parking moves.

For particularly small space requirements during parking, it may be particularly advantageous when at least one of the various parking trajectories is determined by use of the evaluation unit in such a way that the parking maneuver may be performed along three successive circular segments.

The driver of the vehicle may advantageously select the actual parking trajectory directly and easily when the actual parking trajectory is selected by use of the input device of the selection device.

The example method according to the present invention advantageously may be further simplified by the fact that the selection device selects the actual parking trajectory after a period of time. This may also occur, for example, when an input device for selecting a parking trajectory is present, but the input device is not actuated, for example by the driver.

### BRIEF DESCRIPTION OF THE DRAWINGS

Exemplary embodiments of the present invention are schematically illustrated in the figures and described in greater detail below.

FIG. 1 shows a vehicle having a device for assisting a parking maneuver of the vehicle.

FIG. 2 shows a parking maneuver using a single parking move.

FIG. 3 shows a parking maneuver using two parking moves.

FIG. 4 shows another parking maneuver using two parking moves.

FIG. 5 shows a parking maneuver using three parking moves.

### DETAILED DESCRIPTION OF EXAMPLE EMBODIMENTS

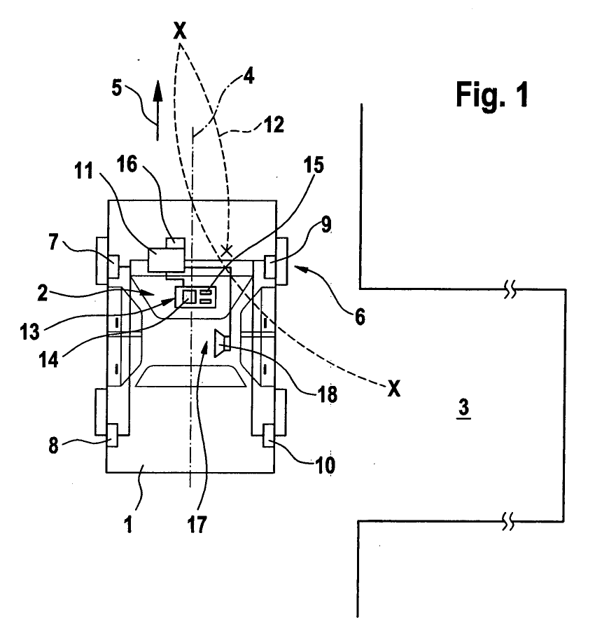

FIG. 1 shows a vehicle 1 designed as a passenger vehicle, having a device 2 for assisting a parking maneuver of vehicle 1 in a parking space 3 situated transverse to vehicle 1. Parking space 3 is situated transverse to longitudinal axis 4 of vehicle 1 to be parked, which is traveling past parking space 3 in a direction indicated by arrow 5. Device 2 has a parking space measuring device with a sensor system 6 which has environment sensors designed as ultrasonic sensors 7, 8, 9, 10 laterally situated on vehicle 1, in the present example two ultrasonic sensors 7, 8 being situated on the left side of the vehicle and two ultrasonic sensors 9, 10 being situated on the right side of the vehicle.

An evaluation unit 11 for determining a parking trajectory 12 of vehicle 1 into parking space 3 is connected to sensor system 6. From a number of different parking trajectories determined by evaluation unit 11, of which only one parking trajectory 12 is illustrated in FIG. 1 as an example, one parking trajectory 12 may be selected as actual parking trajectory 12 by use of a selection device 13 connected to evaluation unit 11.

Selection device 13 has a display device 14, situated in the region of an instrument panel of vehicle 1, having a screen for displaying the various parking trajectories determined by evaluation unit 11. Selection device 13 also has input device 15 for selecting one of the various parking trajectories displayed on the screen of display device 14 as the actual parking trajectory.

Evaluation unit 11 is also provided with a memory unit 16 for storing parking trajectories selected as the particular actual parking trajectory. An output device 17, used for visual output of the screen of display device 14 and for acoustic output of a speaker 18, is provided for transmitting information to an operator of vehicle 1, usually the driver, concerning a vehicle operation for guiding vehicle 1 along the selected parking trajectory 12 into parking space 3.

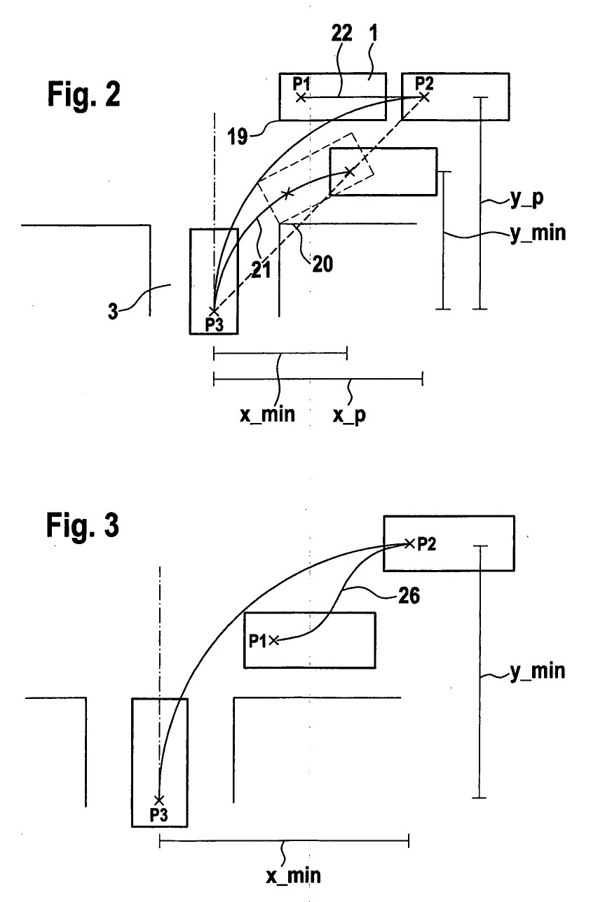

Corresponding elements are provided with the same reference numerals in all the figures. FIG. 2 shows an example of a parking maneuver of a vehicle 1 into a parking space 3 using a single parking move. Such a parking maneuver is possible in principle when the conditions

x_p>x_min and

y_p>y_min

are satisfied, coordinate pair x_min, y_min representing the minimum space requirement and coordinate pair x_p, y_p representing the starting position of vehicle 1 to be parked. Coordinate pair x_min, y_min results from a consideration of rear vehicle corner 19 of vehicle 1 facing parking space 3 possibly colliding with a parking space boundary 20. The associated parking trajectory 21 representing a limiting parking trajectory is indicated by dashed lines in FIG. 2, whereas vehicle 1 in its various positions is illustrated by dotted lines. The limiting parking trajectory requires a full turning of the steering wheel of vehicle 1.

A fixed point on the vehicle is illustrated as destination point P3 in FIG. 2; corresponding to the various positions of vehicle 1 shown by example, this point is illustrated as starting point P1 in a first position of vehicle 1 to be parked, and as intermediate point P2 in a second position of vehicle 1 to be parked.

Based on the minimum space requirement identified by coordinate pair x_min, y_min and destination point P3, the parking trajectory is expanded to give the following expression:

$$\frac{x\_p}{y\_p} = \frac{x\_min}{y\_min} .$$

Use of a best fit line 22 from a starting position identified by starting point P1 to intermediate point P2 allows collision-free parking from intermediate point P2 to destination point P3, and thus into the parked position of vehicle 1 in parking space 3.

If the conditions

x_p>x_min and

y_p>y_min

referenced with respect to FIG. 2 are not satisfied, corresponding to an illustration in FIG. 3 a possible starting position for a parking maneuver—which then uses two parking moves—may be achieved via a best fit travel forward along a forward trajectory 26, starting from a starting point P1 to an intermediate point P2. Forward trajectory 26 may be determined so that the following expression applies:

y_p=y_min.

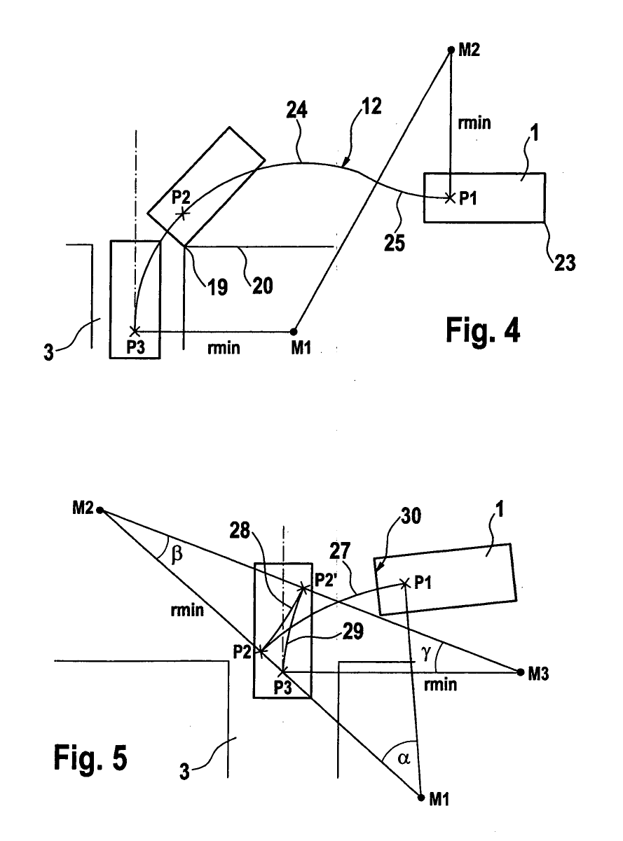

Another parking maneuver of vehicle 1 into a parking space 3 using two parking moves is shown as an example in FIG. 4. Such a parking maneuver using two parking moves may be applicable when vehicle 1 to be parked is at a large distance from parking space 3 in the direction of travel of vehicle 1. In this case, the aim is that a possible collision of front vehicle corner 23 of vehicle 1 facing parking space 3 with a parking space boundary 20 is avoided. Furthermore, midpoint M1—in this case as well as in the description below “midpoint” being understood to mean the center of curvature—of a second partial circle 24 of a parking trajectory 12 is to be determined in such a way that rear vehicle corner 19 facing parking space 3 does not collide with parking space boundary 20. In addition, the conditions

P̅3̅M̅1̅= P̅1̅M̅2̅ and

M̅1̅M̅2̅=2·rmin

must be satisfied, where M2 represents the midpoint of a first partial circle 25 of parking trajectory 12, P1 represents a fixed point on the vehicle as the starting point, P3 represents the fixed point on the vehicle as the destination point, and rmin represents a minimum radius.

FIG. 5 shows a parking maneuver of a vehicle 1 into a parking space 3 using three parking moves, which may be performed along three successive circular segments 27, 28, 29 which are respectively curved in opposite directions. Such a parking maneuver has the smallest space requirement. This parking maneuver is possible when there is no risk of collision of vehicle rear end 30 with a parking space boundary during travel of vehicle 1 and during motion of a fixed point on the vehicle from a starting point P1 to an intermediate point P2.

A first circular travel about a first midpoint M1 and along a first circular segment 27 is completed shortly before vehicle rear end 30 contacts the parking space boundary. Starting at intermediate point P2 which has then been reached, a next intermediate point P2′ is reached by forward travel along a second circular segment 28. This intermediate point P2′ results from the conditions

M̅3̅P̅2̅′̅= M̅2̅P̅2̅′̅=rmin,

where M2 represents the midpoint of second circular segment 28 and M3 represents the midpoint of a third circular segment 29 adjoining second circular segment 28. The particular minimum radius is represented by rmin. Vehicle 1 travels backward along third circular segment 29, about midpoint M3 of third circular segment 29, to a destination point P3. In this exemplary embodiment a straight position of vehicle 1 with respect to parking space 3 is achieved, and for reaching the final parking position vehicle 1 must still move into parking space 3 straight ahead.

1-16. (canceled)

17. A device for assisting a parking maneuver of a motor vehicle, into a parking space situated transverse to the vehicle, comprising:
a parking space measuring device having a sensor system;
an evaluation unit, connected to the sensor system, adapted to determinine a plurality of different parking trajectories of the vehicle into the parking space; and
a selection device connected to the evaluation unit adapted to select a parking trajectory from the plurality of different parking trajectories determined by the evaluation unit.

18. The device as recited in claim 17, wherein the selection device has a display device adapted to display the plurality of different parking trajectories.

19. The device as recited in claim 17, wherein the selection device has an input device adapted to select one of the plurality of different parking trajectories.

20. The device as recited in claim 17, wherein the evaluation unit has a memory unit adapted to store a selected one of the different parking trajectories.

21. The device as recited in claim 17, wherein the sensor system includes a distance-measuring sensor.

22. The device as recited in claim 17, further comprising:
an output device adapted to transmit information to an operator of the vehicle concerning a vehicle operation for guiding the vehicle along the selected parking trajectory into the parking space.

23. A method for assisting a parking maneuver of a motor vehicle into a parking space situated transverse to the vehicle, comprising:
performing, by a parking space measuring device, an at least partial geometric measurement of the parking space before the vehicle is parked in the parking space;
determining, by an evaluation unit, at least two parking trajectories of the vehicle into the parking space based on the measurement; and
selecting one of the determined parking trajectories as an actual parking trajectory using a selection unit.

24. The method as recited in claim 23, further comprising:
simultaneously displaying the determined parking trajectories using a display device.

25. The method as recited in claim 24, wherein the various determined parking trajectories have a sequence.

26. The method as recited in claim 25, wherein the sequence of parking trajectories is a function of a minimum total number of parking moves to be performed for parking along the particular parking trajectory.

27. The method as recited in claim 25, wherein displays of the determined parking trajectories are designated according to the sequences.

28. The method as recited in claim 23, wherein at least one of the determined parking trajectories is determined by use of the evaluation unit so that a parking maneuver may be performed by using a single parking move.

29. The method as recited in claim 23, wherein at least one of the determined parking trajectories is determined by use of the evaluation unit so that a parking maneuver may be performed using two parking moves.

30. The method as recited in claim 23, wherein at least one of the determined parking trajectories is determined by use of the evaluation unit so that a parking maneuver may be performed along three successive circular segments.

31. The method as recited in claim 23, wherein the actual parking trajectory is selected by use of the input device for the selection device.

32. The method as recited in claim 23, wherein the selection device selects the actual parking trajectory after a period of time.
